(19) United States
(12) Patent Application Publication
(10) Pub. No.: US 2014/0149541 A1
(43) Pub. Date: May 29, 2014

(54) Modular Law Enforcement Public Communication Tool

(71) Applicant: Peter Olson, Peabody, MA (US)

(72) Inventor: Peter Olson, Peabody, MA (US)

(21) Appl. No.: 13/889,555

(22) Filed: May 8, 2013

Related U.S. Application Data
(60) Provisional application No. 61/644,177, filed on May 8, 2012.

(51) Int. Cl. G06F 15/173

(52) U.S. Cl. CPC G06F 15/17306
USPC 709/217

(57) ABSTRACT

A modular system of public communication tools for police departments. The public communication tool is comprised of components and each component is optimized after they are associated with a particular law enforcement agency. Modular deployment increases the speed at which a department may evaluate the component, or to reduce the cost, or both. Optimization may include common fields and variables, lookup table generation, ordering of information and rules governing policy, as well as many other components of the system.

### CROSS-REFERENCE TO RELATED APPLICATION

This application claims benefit to U.S. Provisional Application No. 61/644177, filed May 8, 2012.

### FIELD OF THE INVENTION

Various embodiments of the disclosure pertain to a system and methods to provide interaction and information, and more particularly to a system and method to communicate with the public, wherein the information and interaction provided by each law enforcement department is modular and may be customized for each department.

### BACKGROUND OF THE INVENTION

Personal computers have evolved from a system of serially connected systems to a network of computer systems connected by large internal networks and the internet. This evolution is still ongoing, and many different concepts have been tried to connect users with each other and with institutions to access information. How a user interacts with an institution such as a law enforcement department has been a complex problem to solve.

Some programs use a simple approach to interacting with a law enforcement department. For example, a program may simply provide the regional contact information and address of the law enforcement agency with available departmental contacts. A separate program for texting tips to a law enforcement agency, including either anonymous or named tips. For anonymous tips a program may simply remove identifying information before parsing the tip to the law enforcement agency. While a tip for a reward may need to keep identifying information intact. A third program may be used to access a community calendar or solicit input into community programs.

Whenever a law enforcement department wants to provide information to people, they need check to see if any program is available and appropriate for their use. The same goes for people looking to check for information about a law enforcement agency, department, office or program, people must search and find the specified website, application, tool, or software for the particular interaction, from texting a police department, official websites, advocating an officer for a commendation, to find who's in jail, viewing public safety alerts, or accessing information on registered sex offenders.

This approach provides an unwieldy operation to the system administrators. The system administrator needs to maintain all these programs and such as email, calendars, Web pages and texts and Tweets as well as adopt these public communication tools for each department to match their specific needs.

When a user attempts to interact with a law enforcement agency they are often at a loss for which of many ways to interact with the agency, often leading to 911 calls for which there is no emergency.

There are many drawbacks to the disparate measures to interact with people by law enforcement agencies, the first is control as to what the system does and does not support, and the access of the controls associated with supported programs.

Applications and information management systems used by law enforcement should allow control by the systems administrator with a combination of these and other systems. The information to access web sites, instant messenger messages, databases, application should be available to the public in a convenient manner. The public communications system should allow for implementing simple or relatively complex controls on many aspects to the information. The public communications system should also be capable of being used to secure the information to ensure confidentiality, to implement ethical walls, and more.

Therefore, there is a need for improved public communications system for managing information with the public, where the information includes, documents, messages, texts, and more.

### SUMMARY OF THE INVENTION

In a Modular Law Enforcement Public Communication Tool, the public communication system is comprised of components and each component is optimized after they are associated with a particular law enforcement agency. Modular deployment increases the speed at which a department may evaluate the component, or to reduce the cost, or both. Optimization may include common fields and variables, lookup table generation, ordering of information and rules governing policy, as well as many other components of the system.

Advantageously, in an implementation, the invention includes a method for managing a public communication system for a law enforcement agency, where each feature is a module, and the module is independent from other modules. The modules allow a systems administrator access to the information of the module and to control the modules systems based on the modules subset of tools.

Advantageously, in an implementation of the invention, the invention includes a method for managing information provided by users, by providing rules, where the rules include delivering a message directly to the relevant department or officer.

Advantageously, in one embodiment, the invention allows Customized Topics for each department matched with agency email addresses taking the guess work out for citizens and providing them with relevant topics that reach the correct officer based on the departments choice.

Advantageously, in an implementation of the invention includes a method of managing modules including modules for user submitted proposals, where proposals are determined to be relevant to a target, city, state, or nation. The method further includes expression of voting on proposals. In a specific embodiment, a proposal includes voting up or down on proposals.

Advantageously, the invention includes the use of an idea system, allowing other citizens to vote idea up and down and for the agency to accept or reject ideas and also reward public participation via a website or platform.

Advantageously, the invention allows the use of websites or networked databases which include information for public communication. Examples of websites or databases amenable for inclusion in the invention include access to who's in jail, police radio broadcasts, police department Tweets, police department Facebook page, surveys, community calendar and community surveys, and more, as will be evident by this disclosure.

Advantageously, the invention allows for push type notifications to an end user based off a law enforcement department's social media messaging with the ability to customize the message and delivery based on the law enforcement department chosen or based on the end user's location. End users can opt in to notifications from one or more departments and control how the communication is received.

Advantageously, end user's are allowed to choose to receive notifications from a number of separate law enforcement departments where they work, live, children go to school, or other location selected by the end user.

### BRIEF DESCRIPTION OF THE DRAWINGS

The present invention will be better understood by reading the Detailed Description of the various embodiments with reference to the accompanying drawing figures, in which like reference numerals denote similar structure and refer to like elements throughout, and in which:

FIG. 1, in one embodiment, shows a public communication system modules provide communication to end users from a variety of sources;

FIG. 2, shows a modular public communication system directly communicating with end users;

FIG. 3 shows modules of a public communication system connected in a network with a law enforcement agency and end users;

FIG. 4 shows additional modules of a public communication system;

FIG. 5 shows an end user and law enforcement officer is connection with each other;

FIG. 6 shows the My Police Department (MyPD) iPhone application version 1.2;

FIG. 7 shows further modules for the MyPD v1.2 application;

FIG. 8 shows further still modules for the MyPD v.12 application.

The drawings are intended to depict only typical aspects of the invention, and therefore should not be considered as limiting the scope of the invention. In the drawings, like numbering represents like elements between the drawings.

### DESCRIPTION OF PREFERRED EXEMPLARY EMBODIMENTS

In describing the preferred embodiments of the present invention illustrated in the Figures, specific terminology is employed for the sake of clarity. The invention, however, is not intended to be limited to the specific terminology so selected, and it is to be understood that each specific element includes all technical equivalent which operate in a similar manner to accomplish a similar purpose.

The present invention is described with reference to diagrams and operational illustrations of methods and devices. It is understood that each module of the illustrations and combinations of the module illustrations can be implemented by means of analog or digital hardware and computer program instructions. These computer program instructions can be provided to a processor of a general purpose computer, ASIC, or other programmable data processing apparatus, such that the instructions, which execute via the processor of the computer or other programmable data processing apparatus, implements the functions/acts specified in the diagrams.

In some alternate implementations, the functions noted in the diagrams can occur out of the order noted in the illustrations. For example, two operations or modules shown in succession or in a network can in fact be executed substantially concurrently or the operations or modules can sometimes be executed independently, depending upon the functionality involved.

For the purposes of this disclosure the term “server” should be understood to refer to a service point which can provide processing, database, and communication facilities. By way of example, and not limitation, the term: “server” can refer to a single physical processor with associated communications and data storage and database facilities, or it can refer to a network or clustered complex of processors and associated network and storage devices, as well as operating software and one or more database systems and applications software which support the services provided by the server, as well as virtual servers or systems of virtual servers.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

For the purposes of this disclosure a module or component is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine, tool, or an application.

Preferably the Modular Law Enforcement Public Communication Tool has configured modules for each individual police department. Even more preferably the Modular Law Enforcement Public Communication Tool allows an End User 12 to access the modules with a smart phone. In the most preferred embodiment the Modular Law Enforcement Public Communication Tool is a smart phone application and associated server for administering the smart phone application configured with a particular police departments preferences for modules for Department Contacts 23, Latest Tweets 18, Commend an Officer 19, Submit a Tip 20, Questions and Feedback 21, Facebook page 34, News & Alerts 35, Community Survey 36, direct Phone Call 37, and Directions 38.

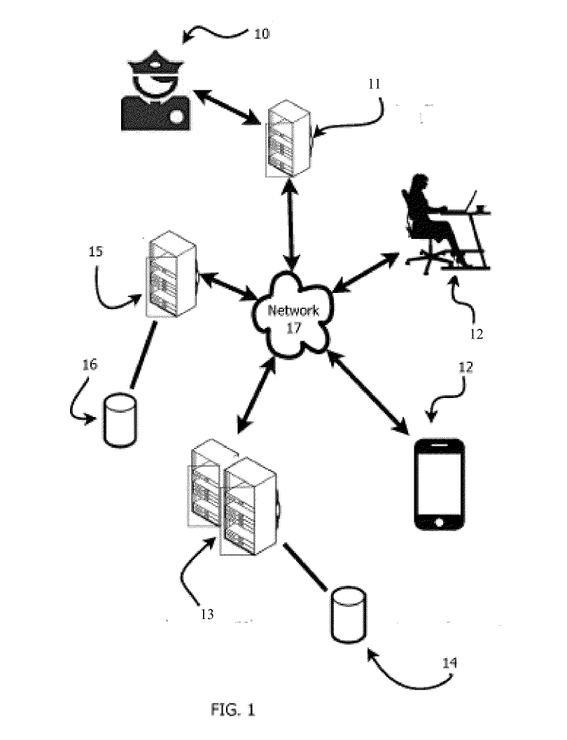

In accord with FIG. 1 in an embodiment of the invention a modular law enforce public communication tool which can be configured according to the needs of an individual law enforcement department, comprises of a Law Enforcement Agency Modular Public Communication Server 11 operationally connected to the Law Enforcement Officer 10 of a law enforcement department. Through a Network 17 information is shared to End Users 12. Communication with Local Information Websites 13 and Local Information Database 14 to End Users 12 depending on the preferences of the law enforcement department or agency. Further communications are facilitated to End Users 12 from Database Server 15 and Database 16. Local Information Websites 13 and Local Information Database 14 in one embodiment include websites that provide local services or local information geographically relative to the particular law enforcement department, for example but not limited to local news, local traffic conditions, local weather alerts. Local Information Websites 13 and Local Information Database 14 in a further embodiment include geographically local information relative to the end users present location or another location selected by the end user.

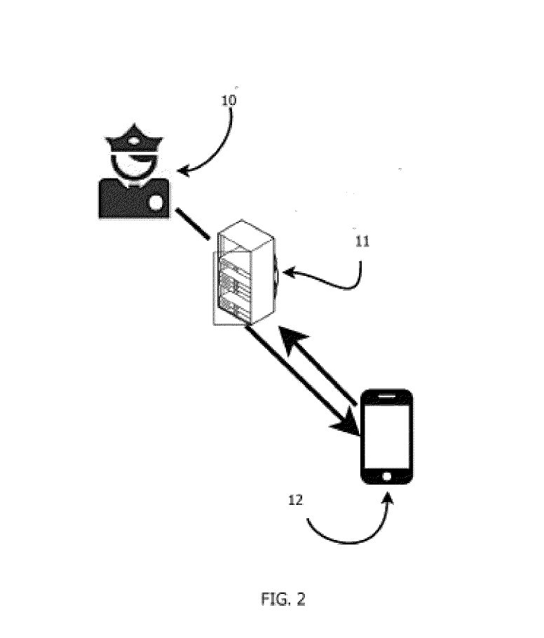

Furthermore, as shown in FIG. 2 a Law Enforcement Officer 10 through a Law Enforcement Agency Modular Public Communication Server 11 communicate directly through a network with End User 12.

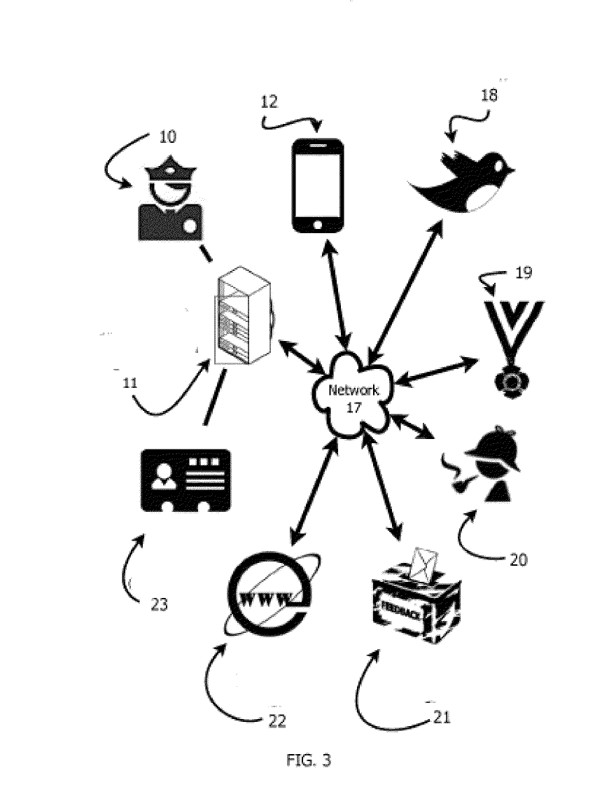

More in detail, the invention provides in FIG. 3 a Modular Law Enforcement Agency Public Communication Tool comprising of a Law Enforcement Officer 10 in connection with a Law Enforcement Agency Modular Public Communication Server. The Modular Law Enforcement Public Communication Tool includes information which can come directly from the Law Enforcement Agency Modular Public Communication Server through a Network 17 to End User 12 or from any number of servers which provide information as a module or component of the Modular Law Enforcement Public Communication Tool. In FIG. 3 the module for Contacts 23, including information but not limited to, such as department phone number, department personnel name, personnel photo, personnel email address, and personnel phone number is located on the Law Enforcement Agency Modular Public Communication Server 11. Using the Modular Law Enforcement Agency Public Communication Tool through a Network 17 End Users 12 may receive information from the module for Contacts 23.

As in FIG. 3 the Latest Tweets 18 from the Twitter account of the Law Enforcement Agency may be displayed for End User 12. Latest Tweets 18 module uses the servers of Twitter to provide the most recent Tweets from within the Modular Law Enforcement Public Communication Tool.

The Commend an Officer module 19 allows an End User 12 using the Modular Law Enforcement Public Communication Tool to recognize an officer who has performed their duties in a manner that an End User 12 thinks is exceptional and reflects favorably upon an officer and the Department. The Commend an Officer module 19 may include details, but is not limited to, such as situation, location, date, and time. Submit a Tip 20 allows an End User 12 to submit information to the Law Enforcement Agency regarding suspicious, nuisance and criminal activity. Submit a Tip 20 information includes but is not limited to location, day, time, wanted suspect's description, known addresses, gang affiliations and other locations a suspect may be found. Information from Submit a Tip 20 may be submitted anonymously or with any contact information provided by the End User 12.

Questions & Feedback 21 provides the End User 12 with the most commonly requested police services and topics an End User 12 needs. Topics include but are not limited to:

Ask the Commissioner

Ask the Public Information Office

Neighborhood Concerns

Incident & Accident Reports

License to Carry & FID Cards

Suggestions/Feedback for App

Submission through the Questions & Feedback module may include the End User 12 contact information, a photo, and GPS coordinates, or may be anonymously.

Department Website 22 provides a module featuring the website of the associated Law Enforcement Department or Agency.

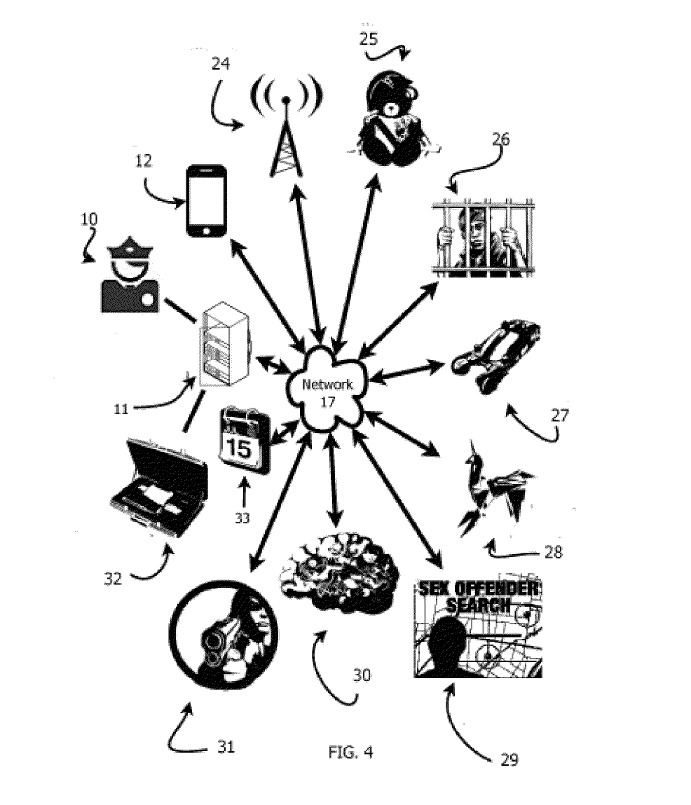

In addition, or alternatively, in FIG. 4 the Modular Law Enforcement Agency Public Communication Tool is shown comprising of a Law Enforcement Officer 10 in connection with a Law Enforcement Agency Modular Public Communication Server 11 and several modules. The Law Enforcement Agency Modular Public Communication Server contains Documents & Forms 32 the particular documents and forms are up to the department to choose to be available through the Public Communication Tool. The End User 12 has access to the contents of each module through the Network 17. A Police Radio 24 module includes a broadcast or re-broadcast of available police radio channels. Games 25 includes but is not limited to educational games and police video games for use by the End User 12, Games 25 can be customized with a particular agencies name, logo, and Chiefs name, etc. Who's in Jail 26 is a module providing access for End Users 12 the information relevant to but not limited to finding an individual, a friend, or family member who may be held in jail. Police Vehicles 27 provides a gallery of police vehicles, including but not limited to police cars, vans, interceptors, and special operations vehicles. Future Applications 28 includes modules and applications that provide flexibility for the Law Enforcement Agency Public Communications Tool to add new modules or features as needed. Sex Offender Search 29 provides information available to End Users 12 regarding sex offenders in their area or an area selected by the End User 12. Police Ideas 30 includes but is not limited to suggestions or plans for local, statewide or national problems. Police Ideas 30 in one embodiment includes the ability to vote up or down ideas proposed by End Users 12. Crime Map 31 in one embodiment but not limited to, provides a map that features the location of crimes in the area of the End User 12 or an area selected by the End User 12. Crime Map 31 in one embodiment includes recent crimes or historical crime data overlaid on a map of the area of the department's jurisdiction. Calendar 33 provides dates, times, and alerts for upcoming events such as police fund raisers, charity events, parades, public events, raffles, gun buy back programs or any other event the police department includes on the Calendar 33.

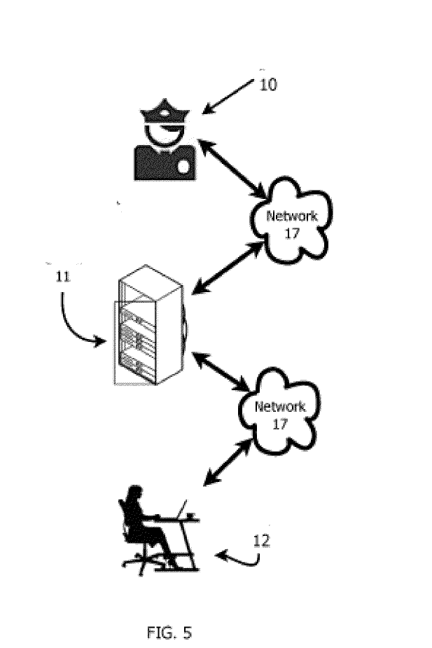

In accord with FIG. 5, the invention comprises a Law Enforcement Officer in connection with a Network 17 to communicate via a Law Enforcement Agency Modular Public Communication Server by a Network 17 with an End User 12.

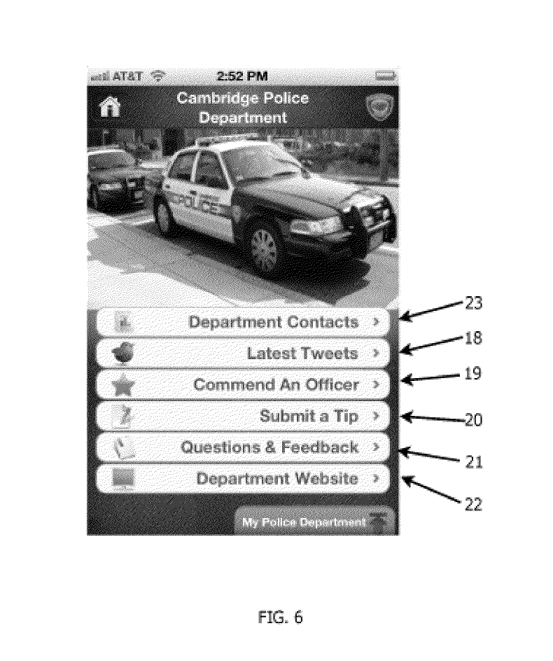

A further variation of the invention is shown in FIG. 6, the iPhone application version of the Modular Law Enforcement Public Communication Tool called My Police Department. As in FIG. 6 the My Police Department v1.2 iPhone application (MyPD) comprises modules for Contacts 23, Latest Tweets 18 from the department, Commend An Officer 19, Submit a Tip 20, Questions & Feedback 21, Department Website 22.

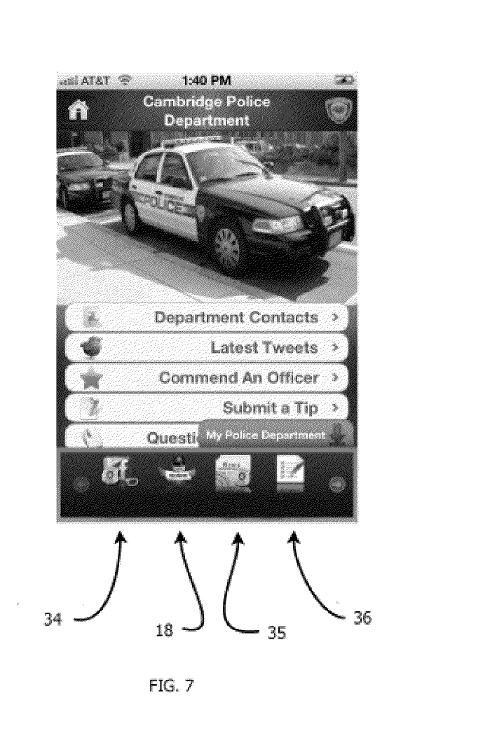

Alternatively, or additionally as in FIG. 7 the Modular Law Enforcement Public Communication Tool in one embodiment of the invention is an iPhone application with links to a law enforcement department Facebook page 34, as well as News & Alerts 35, a Community Survey 36 for an End User's 12 personal experience.

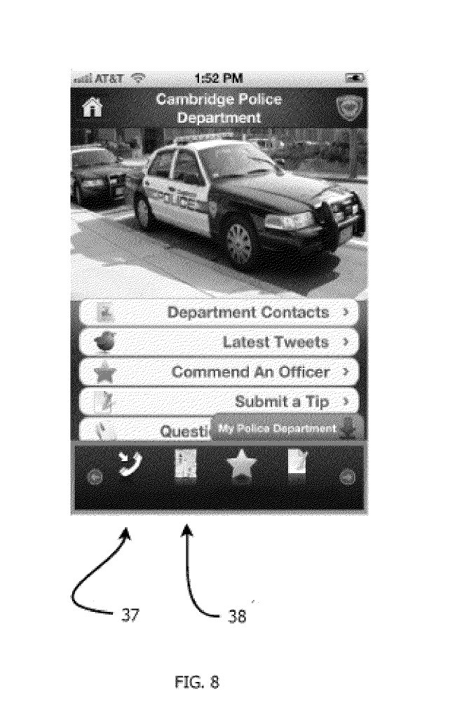

Further still as in FIG. 8. a variation of the Modular Law Enforcement Public Communication Tool includes modules to place a phone Call 37 to call the department, and Directions 38 to the police department or agency head quarters.

The foregoing description of a specific embodiment will so fully reveal the invention according to a conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realize the different functions described herein could have a different nature without, for this reason, departing from the field of the invention. It is to be understood that the phraseology or terminology employed herein is for the purpose of description and not of limitation.

What is claimed is:

1. A method of providing modular law enforcement public communication tools, comprising of one or more modules grouped into an application, said module having a process for communicating with an end user through a network with a law enforcement agency modular public communication server; said modules being independent from each other said module, and said modules are customizable to said law enforcement agency.

2. The method of a modular law enforcement public communication tool of claim 1 further comprising of a database server, in connection with a network; a local information website with a local information database in connection with a network; a law enforcement agency public communication server having a connection through a network with a law enforcement department, wherein the said modular law enforcement public communication tool provides the end user with access to said database server or said local information website.

3. The method of a modular law enforcement public communication tool of claim 1 further comprising a law enforcement officer in connection with a law enforcement agency public communication server, wherein said law enforcement public communication server connects directly through a network with an end user having a software application configured for access through said network.

4. The method of modular law enforcement public communication tool of claim 1 wherein one of the said modules has a Commend an Officer process.

5. The method modular law enforcement public communication tool of claim 1 wherein one of the said modules has a Who's In Jail process.

6. The method of a modular law enforcement public communication tool of claim 1 wherein one of the said modules has a Police Radio process.

7. The method of a modular law enforcement public communication tool of claim 1 wherein one of the said modules has a Sex Offender Search.

8. The method of a modular law enforcement public communications tool of claim 1 wherein a module includes customized topics for each department matched with police agency email addresses.

9. The method of a modular law enforcement public communications tool comprising of a plurality of modules, wherein the invention includes a module for a Police Idea system, allowing other citizens to vote an idea up and down, and for the agency to accept or reject ideas.

10. A modular police communication tool, comprising
a. a computing device configured to establish relationships between a police department and a person,
b. receiving data from a person through said computing device,
c. providing a specific communication back to the person according to a module,
d. wherein the computing device allows one or more modules to be defined by the police department.

11. The modular police communication tool of claim 10 wherein the computing device is a smart phone.

12. The modular police communication tool of claim 10 wherein the computing device is configured with a module chosen from the group consisting of Department Contacts, Department Website, Latest Tweets, Commend an Officer, Submit a Tip, Questions and Feedback, Facebook, News & Alerts, Community Survey, Direct Phone Call, and Directions.

13. The modular police communication tool of claim 10 wherein the computing device is configured with a module chosen from the group consisting of Games, Who's In Jail, Police Vehicles, Future Applications, Sex Offender Search, Police Ideas, Crime Map, Calendar, Documents & Forms, Police Radio, Fire Department Radio, First Responder Radio.

14. The modular police communication tool of claim 10 further including a module for a Police Idea system, allowing other citizens to vote an idea up and down, and for the police department to accept or reject ideas.

15. The modular police communication tool of claim 10 wherein one of the said modules is a Questions & Feedback module with one or more sub categories chosen from the group consisting of
Ask the Commissioner,
Ask the Public Information Office,
Neighborhood Concerns,
Incident & Accident Reports,
License to Carry & FID Cards,
Suggestions/Feedback for App.

16. The modular public communication tool of claim 10 wherein one of the said modules is a Games module.

17. The modular police communication tool of claim 10 wherein one of the said modules is a Sex Offender Search.

18. The modular police communication tool of claim 10 wherein one of the said modules is a Commend an Officer module.

19. The modular police communication tool of claim 10 wherein the specific communication is a communication from a Law Enforcement Officer.

20. A modular police communication tool, comprising:
One or more modules selected by a police department,
A means for communicating with the public through the said one or more modules.
